(19) United States
(12) Patent Application Publication
(10) Pub. No.: US 2022/0292349 A1
(43) Pub. Date: Sep. 15, 2022

(54) DEVICE AND COMPUTER-IMPLEMENTED METHOD FOR THE PROCESSING OF DIGITAL SENSOR DATA AND TRAINING METHOD THEREFOR

(71) Applicant: Robert Bosch GmbH, Stuttgart (DE)

(72) Inventors: Danny Oliver Stoll, Freiburg (DE); Frank Hutter, Freiburg Im Breisgau (DE); Jan Hendrik Metzen, Boeblingen (DE); Thomas Elsken, Sindelfingen (DE)

(73) Assignee: Robert Bosch GmbH, Stuttgart (DE)

(21) Appl. No.: 17/625,041

(22) PCT Filed: Jun. 24, 2020
(86) PCT No.: PCT/EP2020/067689

§ 371 Date: Jan. 5, 2022

(30) Foreign Application Priority Data
Jul. 16, 2019 (DE) 10 2019 210 507.6

(51) Int. Cl. G06N 3/08; G06N 3/04

(52) U.S. Cl. CPC G06N 3/08; G06N 3/04

(57) ABSTRACT

A device, computer-implemented method for the processing of digital sensor data and training methods therefor. A plurality of training tasks from a distribution of training tasks are provided, the training tasks characterizing the processing of digital sensor data. A parameter set for an architecture and for weights of an artificial neural network are determined with a first gradient-based learning algorithm and with a second gradient-based algorithm as a function of at least one first training task from the distribution of training tasks. The artificial neural network is trained with the first gradient-based learning algorithm as a function of the parameter set and as a function of a second training task.

### FIELD

The present invention is directed to a device and to a computer-implemented method for the processing of digital sensor data. The present invention also relates to a training method therefor.

### BACKGROUND INFORMATION

Artificial neural networks are suitable for processing digital sensor data. Training artificial neural networks requires large amounts of this data and a high expenditure of time and computing effort.

It is desirable to specify an approach that is an improvement over the related art.

### SUMMARY

This may be achieved by an example embodiment of the present invention.

In accordance with an example embodiment of the present invention, a computer-implemented method for the processing of digital sensor data provides that a plurality of training tasks from a distribution of training tasks is provided, the training tasks characterizing the processing of digital sensor data, a parameter set for an architecture and for weights of an artificial neural network being determined with a first gradient-based learning algorithm and a second gradient-based learning algorithm as a function of at least one first training task from the distribution of training tasks, the artificial neural network being trained with the first gradient-based learning algorithm as a function of the parameter set and as a function of a second training task, digital sensor data being processed as a function of the artificial neural network. The training tasks that characterize the digital sensor data may be previously recorded, simulated or calculated for off-line training. Both the architecture as well as the weights of the artificial neural network are therefore trainable with the at least one first training task in a first training phase for a specific application or independently of a specific application. Thus, for the specific application, a training may be carried out in a second training phase with only one second training task. This significantly reduces the training effort in an adaptation, in particular, if the second training tasks correlate well with the first training tasks. For example, an adaptation of the artificial neural network to a new sensor, which is used in a system for a previous sensor, is therefore possible with little training effort. As a result, a model for machine learning is provided, which has already been optimized for particular training tasks. For deep neural networks, in particular, there is the possibility of easily adapting such an a priori optimized model for machine learning to a new training task. Fast in this case means, for example, using very few new characterized training data, in a short period of time and/or with little computing effort as opposed to the training that was necessary for the a priori optimization.

In accordance with an example embodiment of the present invention, the artificial neural network is preferably defined by a plurality of layers, elements of the plurality of the layers including a shared input and defining a shared output, the architecture of the artificial neural network being defined by parameters in addition to the weights for the neurons in the elements, each of the parameters characterizing a contribution of one of the elements of the plurality of layers to the output. The elements are situated in parallel, for example. The parameters indicate by their values, for example, which contribution an element to which a parameter is assigned makes to the output. In addition to the weights, the outputs of individual elements are weighted by the values, which the artificial neural network provides for the neurons in the elements.

In accordance with an example embodiment of the present invention, the artificial neural network is preferably trained in a first phase with the first gradient-based learning algorithm and the second gradient-based learning algorithm as a function of a plurality of first training tasks, the artificial neural network being trained in a second phase as a function of a second training task and as a function of a first gradient-based learning algorithm and independently of the second gradient-based learning algorithm. The first phase takes place, for example, with first training tasks, which originate from a generic application, in particular, offline. The second phase takes place, for example, for adaptation to a specific application with second training tasks, which originate from an operation of a specific application. The second training phase is carried out, for example, during operation of the application.

The artificial neural network is preferably trained in a first phase as a function of a plurality of first training tasks, the artificial neural network being trained in a second phase as a function of a fraction of the training data from the second training task. In this way, a previously pre-trained artificial neural network is adapted with little effort to a new application with respect to the architecture and the weights.

At least the parameters of the artificial neural network, which define the architecture of the artificial neural network, are preferably trained with the second gradient-based learning algorithm.

In accordance with an example embodiment of the present invention, a method is preferably provided for activating a computer-controlled machine, in particular, of an at least semi-autonomous robot, of a vehicle, of a home application, of a power tool, of a personal assistance system, of an access control system, training data for training tasks being generated as a function of digital sensor data, a device for machine learning, in particular, for regression and/or for classification, and/or another application that includes an artificial neural network, being trained with the aid of training tasks according to the described method, the computer-controlled machine being activated as a function of an output signal of the device thus trained. The training data are detected for the specific application and, in particular, used for training in the second training phase. This facilitates the adaptation of the artificial neural network and enables immediate use.

The training data preferably include image data, video data and/or digital sensor data of a sensor, in particular, from a camera, from an infrared camera, from a LIDAR sensor, from a radar sensor, from an acoustic sensor, from an ultrasonic sensor, from a receiver for a satellite navigation system, from a rotational speed sensor, from a torque sensor, from an acceleration sensor and/or from a position sensor. These are particularly suitable for automation.

In accordance with an example embodiment of the present invention, a computer-implemented method for training a device for machine learning, classification or activation of a computer-controlled machine provides that a plurality of training tasks from a distribution of training tasks is provided, the training tasks characterizing the processing of digital sensor data, a parameter set for an architecture and for weights of an artificial neural network being determined with a first gradient-based learning algorithm and a second gradient-based learning algorithm as a function of at least one first training task from the distribution of training tasks. Thus, this device is trained independently of the specific application and prior to the use subsequently as a function of the specific device and is thus prepared for use in a specific application.

It is preferably provided that the artificial neural network is trained with the first gradient-based learning algorithm as a function of the parameter set and as a function of a second training task. An adaptation to new training tasks may therefore be efficiently implemented.

In accordance with an example embodiment of the present invention, a device for processing digital sensor data, in particular, for machine learning, classification or activation of a computer-controlled machine includes a processor and a memory for at least one artificial neural network, which are designed to carry out the method. This device may be prepared regardless of the specific application and may be subsequently trained as a function of the specific application.

### BRIEF DESCRIPTION OF THE DRAWINGS

Further advantageous specific embodiments result from the following description and from the figures.

FIG. 1 schematically shows a representation of parts of a device for the processing of digital sensor data, in accordance with an example embodiment of the present invention.

FIG. 2 schematically shows a representation of parts of an artificial neural network, in accordance with an example embodiment of the present invention.

FIG. 3 shows steps in a computer-implemented method for the processing of digital sensor data, in accordance with an example embodiment of the present invention.

FIG. 4 shows steps in a method for activating a computer-controlled machine, in accordance with an example embodiment of the present invention.

FIG. 5 shows steps in a computer-implemented method for training, in accordance with an example embodiment of the present invention.

### DETAILED DESCRIPTION OF EXAMPLE EMBODIMENTS

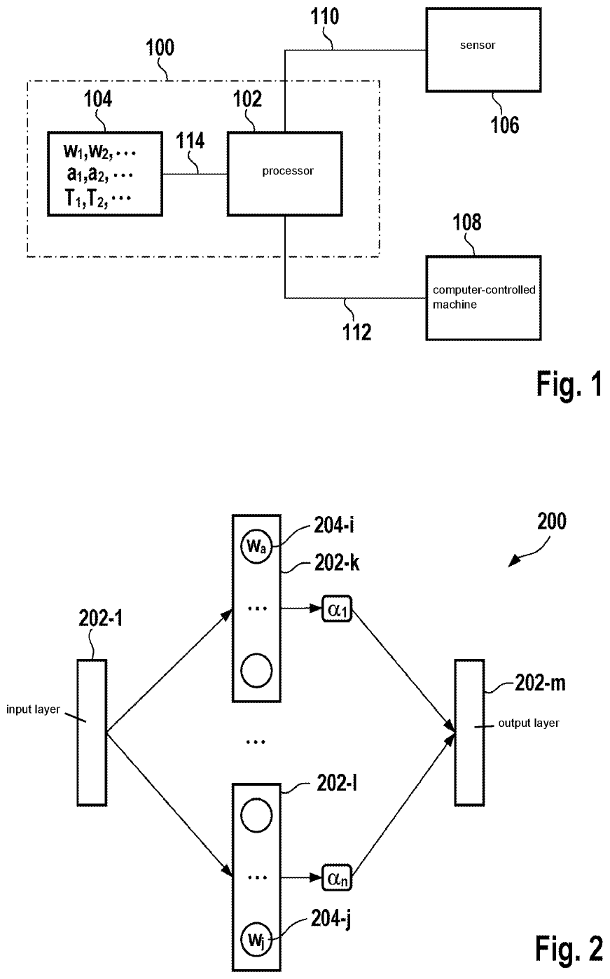

A device 100 for processing digital sensor data is schematically represented in FIG. 1. Device 100 includes a processor 102, and a memory 104. A sensor 106 is provided in the example for detecting digital sensor data. Device 100 in the example is designed for activating a computer-controlled machine 108. Device 100 may also be designed for machine learning or for a classification.

Sensor 106 in the example is connectable via a signal line 110 to processor 102. Processor 102 in the example is designed to receive digital signals of sensor 106 and to store them as training data in memory 104. The training data include, for example, image data, video data and/or other digital sensor data of sensor 106. The training data may be at least partially detected in an operation of device 100 with sensor 106. Training data may also be digital signals detected independently of sensor 106 or provided independently of sensor 106.

Sensor 106 may be, in particular, a camera, an infrared camera, a LIDAR sensor, a radar sensor, an acoustic sensor, an ultrasonic sensor, a receiver for a satellite navigation system, a rotational speed sensor, a torque sensor, an acceleration sensor and/or a position sensor. Multiple of these sensors may be provided.

Computer-controlled machine 108 in the example is connected to processor 102 via a signal line for an output signal 112. Processor 102 in the example is designed to activate computer-controlled machine 108 as a function of the digital signals.

Computer-controlled machine 108 is, in particular, an at least semi-autonomous robot, a vehicle, a home application, a power tool, a personal assistance system, or an access control system.

Memory 104 and processor 102 in the example are connected to a signal line 114. These components may be implemented in a server infrastructure, in particular, in a distributed manner. Device 100 may also be a control unit, which includes these components integrated into a microprocessor.

Device 100 is designed to carry out the method or one of the methods described below.

Device 100 includes at least one artificial neural network. An exemplary artificial neural network 200 is schematically represented in FIG. 2.

Artificial neural network 200 is defined by a plurality of layers 202-1, . . . , 202-m. In the example, an input 202-1 and an output 202-m are defined by one each of the plurality of layers 202-1, . . . , 202-m. Input 202-1 may be the input layer of artificial neural network 200 or a hidden layer of artificial neural network 200. Output 202-m may be an output layer of artificial neural network 200 or a hidden layer of artificial neural network 200.

Particular elements 202-k, . . . , 202-l of the plurality of layers 202-1, . . . , 202-m include input 202-1 as a shared input. Elements 202-k, . . . , 202-l in the example define output 202-m as a shared output of elements 202-k, . . . , 202-l. This means, elements 202-k, . . . , 202-l are situated in parallel in artificial neural network 200 with respect to their shared input and with respect to their shared output.

Artificial neural network 200 includes, for example, only one single hidden layer. This hidden layer includes multiple parallel elements. For example, a first element 202-k is provided, which is designed as a 3×3 convolution. For example, a second element not represented in FIG. 2 is provided, which is designed as a 5×5 convolution. For example, a third element 202-l is provided, which is designed as MaxPooling. These three elements are situated in parallel and form a search space made up of the three elements {Conv3×3, Conv5×5, MaxPool}.

One mathematical function, which describes for each of these three elements its output as a function of a shared input is specifiable, for example, as follows:

output=Conv3×3(input),

output=Conv5×5(input),

output=MaxPool(input).

One mathematical function, which describes a shared output of these three elements as a function of the shared input, is specifiable, for example, as follows:

output=α₁*Conv3×3(input)+α₂*Conv5×5(input)+α₃*MaxPool(input)

More generally, the architecture of artificial neural network 200 is defined, in addition to weights wₐ, . . . , wⱼ for neurons 204-i, . . . , 204-j in elements 202-k, . . . , 202-l, by parameters α₁, . . . , αₙ. Each of parameters α₁, . . . , αₙ characterizes a contribution of one of elements 202-k, . . . , 202-l to the shared output. In the example, parameters α₁, . . . , αₙ are defined for n=l-k elements. In the example, one of the parameters α₁, . . . , αₙ determines in a multiplication for all outputs of an individual element its contribution to the output of the layer.

By correspondingly determining parameters α₁, . . . , αₙ, it is possible that one of elements 200-k, . . . , 202-l specifically alone determines the result at the output of the layer. In the example, this would be achievable by only one value different from zero of exactly one of parameters α₁, . . . , αₙ. Of the three elements {Conv3×3, Conv5×5, MaxPool} described by way of example, α₁=0, α₂=1 and α₃=0, for example, means that only the output of the Conv5×5 is considered, i.e., an architecture including the Conv5×5 layer. In the case of α₁=1, α₂=0 and α₃=0, the result is an architecture including the Conv3×3 layer. In general, the parameter for each of elements 202-k, . . . , 202-l is determined with an approach described below, by determining artificial neural network 200, in which all elements 202-k, . . . , 202-l are present in parallel to one another. Each element 202-k, . . . , 202-l in this case is weighted by a real-valued parameter α₁, . . . , αₙ.

Parameters α₁, . . . , αₙ need not necessarily be 0 or 1, but may assume arbitrary real-valued numbers, for example, α₁=0.7, α₂=0.2 and α₃=0.1. This represents a relaxation of the search space. For example, a boundary condition for parameters α₁, . . . , αₙ is selected in such a way that a sum of parameters α₁, . . . , αₙ results in the value one. This is possible, for example, by determining real-valued values for parameters α₁, . . . , αₙ and standardizing the values for parameters α₁, . . . , αₙ with the sum of all values. This relaxation represents a weighting of individual elements 200-k, . . . , 200-l in the architecture of artificial neural network 200 defined by all these elements 202-k, . . . , 202-l.

A simple optimization of the architecture is possible with these, in particular, real-valued parameters α₁, . . . , αₙ. The optimization uses, for example, a gradient-based algorithm. A stochastic gradient descent is preferably used. The same type of algorithms are particularly preferably used, which is used for the optimization of weights wₐ, . . . , wⱼ for neurons 204-i, . . . , 204-j in elements 202-k, . . . , 202-l.

Artificial neural network 200 in FIG. 2 represents an example of such an arrangement of parallel elements 202-k, . . . , 202-l. In general, an artificial neural network may include an arbitrary number of such parallel elements, in particular, in different successive hidden layers. It may also be provided to arrange at least one of the elements in parallel to another element or to multiple serially arranged elements.

Such elements of the artificial neural network optimized by the determination of parameters α₁, . . . , αₙ are parts that include a shared input and that define a shared output. Multiple such layers may be provided, which include respective inputs and outputs. Each of the hidden layers, in particular, may be structured in this manner. A respective input and output may be provided for each of these layers.

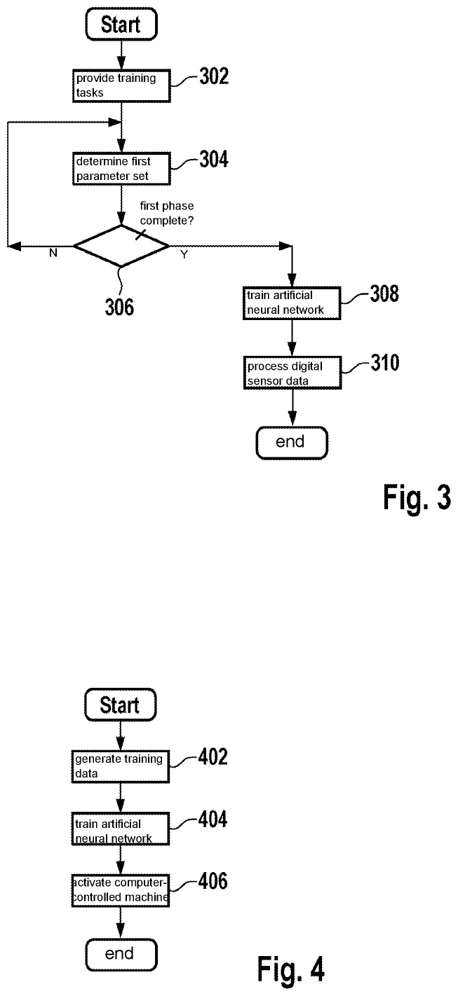

A computer-implemented method for the processing of digital sensor data with such an artificial neural network is described with reference to FIG. 3 as exemplified by artificial neural network 200.

In a step 302, a plurality of p training tasks T₁, T₂, . . . , Tₚ from a distribution p(T) of training tasks T is provided.

A meta-architecture aₘₑₜₐ is also provided in the example for the three elements {Conv3×3, Conv5×5, MaxPool}. Meta-architecture aₘₑₜₐ is defined in this example as

aₘₑₜₐ=(0.7, 0.2, 0.1)

These may be random, in particular, real-valued variables from zero to one. In the example, meta-weights wₘₑₜₐ are also initially defined.

Training tasks T in the example characterize the processing of digital sensor data. These are data, for example, which have been detected by a sensor, or determined as a function of data detected by a sensor, or which correlate with the latter. These may be based on image data, video data and/or digital sensor data of sensor 106. Training tasks T characterize, for example, an assignment of the digital sensor data to a result of the processing. An assignment to a classification of an event, in particular, for at least semi-autonomous controlling of machine 108 may defined as a training task, in particular, for digital sensor data from the at least one camera, from the infrared camera, from the LIDAR sensor, from the radar sensor, from the acoustic sensor, from the ultrasonic sensor, from the receiver for the satellite navigation system, from the rotational speed sensor, from the torque sensor, from the acceleration sensor and/or from the position sensor. Corresponding training tasks may be defined for machine learning or regression.

In a subsequent step 304, at least one first parameter set W₁, A₁ for an architecture and for weights of an artificial neural network is determined with a first gradient-based learning algorithm as a function of at least one first training task from the distribution of training tasks T. First parameter set W₁, A₁ includes a first parameter set A₁ for parameters α₁, . . . , αₙ and a first set W₁ for weights wₐ, . . . , wⱼ. First set W₁ for the weights may also include values for all other weights of all other neurons of artificial neural network 200 or of a portion of the neurons of artificial neural network 200. The last parameter value set aᵢ resulting from the gradient descent method described below defines first parameter value set A₁. The last set wᵢ with the weights resulting from the gradient descent method described below defines the first set W₁ for the weights.

The first gradient-based learning algorithm includes for a particular training task Tᵢ a parameter value set aᵢ including parameters α_{1,i}, . . . , α_{n,i} and a set wᵢ including weights w_{a,i}, . . . , w_{j,i}, for example, an assignment

(wᵢ, aᵢ)=ϕ(wₘₑₜₐ, aₘₑₜₐ, Tᵢ)

The meta-architecture is identified with aₘₑₜₐ. The meta-weights are identified with wₘₑₜₐ.

In this case, ϕ is an algorithm, in particular, an optimization algorithm, training algorithm or learning algorithm, which optimizes for a specific training task both the weights as well as the architecture of a neural network for this training task. With the implementation of algorithm ϕ, for example, k steps gradient descent are carried out in order to optimize the weights and the architecture. Algorithm ϕ may be designed like the DARTS algorithm for the calculation. DARTS refers to the algorithm “Differentiable Architecture Search,” Hanxiao Liu, Karen Simonyan, Yiming Yang; ICRL; 2019; https://arxiv.org/abs/1806.09055.

As a function of this training task Tᵢ, an optimized architecture aᵢ is determined in the example as a function of initial meta-architecture aₘₑₜₐ and initial weights wₘₑₜₐ as

aᵢ=(0.8, 0.0, 0.2)=(α₁, α₂, α₃)

In addition, an optimized set wᵢ is determined for weights w_{a,i}, . . . , w_{j,i}.

Index i signals that aᵢ has been ascertained from the i-th training task Tᵢ. This means, parameters α_{1,i}, . . . , α_{n,i} are a function of i-th training task Tᵢ and may vary depending on training task Tᵢ.

In the example, optimized architecture aᵢ as a function of another training task Tᵢ may also be determined as a function of the initial meta-architecture as

aᵢ=(0.0, 1.0, 0.0)=(α₁, α₂, α₃)

In addition, an optimized set wᵢ is determined for weights w_{a,i}, . . . , w_{j,i}.

At least one parameter, which defines the contribution of at least one of the elements to the output, is determined as a function of the second gradient-based learning algorithm. In the example, parameters α₁, . . . , αₙ are determined.

The second gradient-based learning algorithm includes, for example, for plurality p of training tasks T₁, . . . , Tₚ an assignment

(wₘₑₜₐ, aₘₑₜₐ)=Ψ(wₘₑₜₐ, w₁, . . . , wₚ, aₘₑₜₐ, a₁, . . . , aₚ, T₁, Tₚ)

A meta-learning algorithm is identified with Ψ. Meta-learning algorithm Ψ optimizes meta-architecture aₘₑₜₐ together with meta-weights wₘₑₜₐ as a function of a series of training tasks T₁, . . . , Tₚ including associated optimized architectures a₁, . . . , aₚ and associated optimized weights w₁, . . . , wₚ. The optimized architectures are represented by parameter value sets a₁, . . . , aₚ. The optimized weights are represented by sets w₁, . . . , wₚ for the weights.

Meta-learning algorithm Ψ is, for example, the MAML algorithm. MAML refers to the algorithm Model-Agnostic Meta-Learning for Fast Adaptation of Deep Networks, Chelsea Finn, Pieter Abbeel, Sergey Levine; Proceedings of the 34^{th} International Conference on Machine Learning; 2017; https://arxiv.org/pdf/1703.03400.pdf. In contrast to meta-learning algorithms, which meta-learn iteratively the weights of a neural network such as, for example, the original MAML algorithm, in which only weights w of a fixed neural network are meta-learned, the architecture of neural network 200 is thereby also meta-learned.

For a real-valued representation of the architecture of the artificial neural network, gradients in the architecture space are also calculated in the example for the architecture parameters with the MAML algorithm. Both the weights as well as the architecture are optimized with this gradient descent method.

For example, the following equation is minimized by gradient descent methods.

$${min}_{{w}_{meta} , {a}_{meta}} {\sum }_{T} Loss ( T , ϕ )$$

Subsequently, it is checked in a step 306 whether a first phase is completed.

Artificial neural network 200 in the example is trained in the first phase with the first gradient-based learning algorithm and the second gradient-based learning algorithm as a function of the plurality of first training tasks T₁, . . . , Tₚ.

First parameter value set A₁ for parameters α₁, . . . , αₙ and first set W₁ for weights wₐ, . . . , wⱼ define in the example artificial neural network 200 after a training with the DARTS and with the MAML algorithm.

The first phase is completed, for example, when a stop criterion applies. The stop criterion is, for example, the reaching of a time threshold or a resource budget. If the first phase is completed, a step 308 is carried out. Otherwise, step 304 is carried out.

In step 308, artificial neural network 200 is trained with the first gradient-based learning algorithm as a function of first parameter set W₁, A₁ and as a function of a second training task. The last parameter set aᵢ resulting from the training with the first gradient-based learning algorithm defines a second parameter set A₂. The last set wᵢ including the weights resulting from the training with the first gradient-based learning algorithm defines a second set W₂ for the weights.

This means, artificial neural network 200 is trained as a function of a new training task and as a function of a first gradient-based learning algorithm and independently of the second gradient-based learning algorithm. Second parameter value set A₂ for parameters α₁, . . . , αₙ and second set W₂ for weights wₐ, . . . , wⱼ define in the example neural network 200 after the completed training only with the DARTS algorithm.

Subsequently, digital sensor data are processed in a step 310 as a function of the trained artificial neural network 200.

The method subsequently ends.

In one aspect, artificial neural network 200 is trained in the first phase as a function of a plurality of first training tasks and in the second phase as a function of a fraction of the training data, in particular, from only one second training task.

Steps in a method for activating computer-controlled machine 108 are described below with reference to FIG. 4.

The method for activating computer-controlled machine 108 starts, for example, when the machine is to be trained. In one aspect, artificial neural network 200 is trained in the first phase as previously described, and implemented in device 100 for machine learning, for example, for regression and/or for classification. Device 100 activates computer-controlled machine 108 according to the method. The method starts, for example, after the switch-on of computer-controlled machine 108, in which this artificial neural network 200 is implemented. It may also trigger an event such as, for example, an exchange of sensors 106 or a software update for sensor 106 or the start for computer-controlled machine 108.

After the start, training data for second training tasks are generated in a step 402 as a function of digital sensor data 110. The training data may be image data, video data and/or digital sensor data of sensor 106. For example, image data from the camera or from the infrared camera are used. The image data may also originate from the LIDAR sensor, from the radar sensor, from the acoustic sensor or from the ultrasonic sensor. The training data may also include positions of the receiver for the satellite navigation system, rotational speeds from rotational speed sensors, torques from torque sensors, accelerations from acceleration sensors and/or position information from position sensors. The training data correlate in the example with the training data, which are used in the first phase for the training of artificial neural network 200. The training tasks also correlate. During the exchange of sensor 106 or during the initial start-up of computer-controlled machine 108 with sensor 106, for example, first training tasks from the first phase may be used, in which generic sensor data used for the first phase are replaced by the actual sensor data determined by sensor 106.

In a subsequent step 404, artificial neural network 200 is trained with the aid of the second training tasks. In one aspect, artificial neural network 200 is trained as previously described for the second phase. In this way, device 100 is trained.

In a subsequent step 406, computer-controlled machine 108 is activated as a function of output signal 112 of device 100 trained in this way.

The method subsequently ends, for example, when computer-controlled machine 108 is switched off.

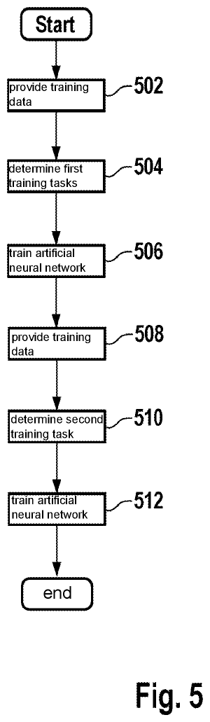

Steps in a computer-implemented method for training are described below with reference to FIG. 5.

After the start, a step 502 is carried out.

In step 502, training data are provided for the first training tasks according to the first phase. The training data are provided, for example, in a database.

In a subsequent step 504, the first training tasks for the first phase are determined. For example, p(T) is determined for the distribution of the training tasks for the first phase and the first training tasks from distribution p(T) are sampled. The second training tasks or the second training task need not be given or known at this point in time.

Artificial neural network 200 is subsequently trained in a step 506 with the aid of the first training tasks according to the first phase.

One exemplary implementation is reproduced below for distribution p(T) of the first training tasks. while (<some stopping criterion such as time or resource budget>):

sample tasks T₁, T₂, . . . , Tₚ from p (T)

for all Tᵢ:

(wᵢ, aᵢ)=ϕ(wₘₑₜₐ, aₘₑₜₐ, Tᵢ)

(wₘₑₜₐ, aₘₑₜₐ)=Ψ(wₘₑₜₐ, w₁, . . . , wₚ, aₘₑₜₐ, a₁, . . . , aₚ, T₁, . . . , Tₚ)

return (wₘₑₜₐ, aₘₑₜₐ)

The method subsequently ends.

It may optionally be provided that artificial neural network 200 is trained with the aid of the second training tasks or of only one second training task according to the second phase.

In a step 508, the training data are provided for the second training tasks or only for the second training task according to the second phase.

At least one second training task for the second phase is subsequently determined in a step 510.

Subsequently, artificial neural network 200 is trained as a function of the at least one second training task according to the second phase. An exemplary implementation of step 512 is reproduced below for a single second training task T:

(w_{T}, a_{T})=ϕ(wₘₑₜₐ, aₘₑₜₐ, T)

return w_{T}, a_{T}

The training tasks from the training task sets are predefinable independently of one another. A result of the training may be determined as a function of the first phase of the method and as a function of only one new training task. Step 510 may, if needed, be applied to various new training tasks, these are then independent of one another.

The methods described may be used in order to make predictions with artificial neural network 200, in particular, as a function of received sensor data. It may also be provided to extract received sensor data with the artificial neural network via sensors 106.

In the first phase, generic training data may be used for sensors of a particular sensor class, which includes, for example, sensor 106. Thus, when exchanging sensor 106, artificial neural network may be easily adapted to a switch of a hardware or software generation through training in the second phase.

A traffic sign recognition, for example, represents a specific other application. For example, country-specific traffic signs are used in the first phase, which exist only for a few countries, for example, Germany or Austria. Artificial neural network 200 is trained in the first phase with first training data based on these country-specific traffic signs. If the traffic sign recognition is to be used in other countries, artificial neural network 200 is trained in the second phase with a few second training data with traffic signs that are specific for these other countries.

1-12. (canceled)

13. A computer-implemented method for processing digital sensor data, the method comprising the following steps:
providing a plurality of training tasks from a distribution of training tasks, the training tasks characterizing processing of digital sensor data;
determining a parameter set for an architecture and for weights of an artificial neural network in a first phase with a first gradient-based learning algorithm and with a second gradient-based learning algorithm as a function of a plurality of first training tasks from the distribution of training tasks, the second gradient-based learning algorithm being a meta-learning algorithm, which ascertains an optimized parameter set as a function of the plurality of first training tasks and the parameter set;
training the artificial neural network in a second phase with the first gradient-based learning algorithm as a function of the optimized parameter set as a function of one second training task; and
processing the digital sensor data as a function of the artificial neural network.

14. The method as recited in claim 13, wherein the artificial neural network is defined by a plurality of layers, elements of the plurality of the layers including a shared input and defining a shared output, the architecture of the artificial neural network being defined, in addition to the weights for neurons in the elements, by parameters, each of the parameters characterizing a contribution of one of the elements of the plurality of layers to the output.

15. The method as recited in claim 13, wherein the artificial neural network is trained in the second phase as a function of a second training task and as a function of the first gradient-based learning algorithm and independently of the second gradient-based learning algorithm.

16. The method as recited in claim 15, wherein the artificial neural network is trained in the first phase as a function of the plurality of first training tasks, the artificial neural network being trained in the second phase as a function of a fraction of the training data from the second training task.

17. The method as recited in claim 16, wherein at least the parameters of the artificial neural network that define the architecture of the artificial neural network are trained with the second gradient-based learning algorithm.

18. A method for activating a computer-controlled machine, the method comprising the following steps:
generating training data for training tasks as a function of digital sensor data;
training a device which includes an artificial neural network by:
providing a plurality of training tasks from a distribution of the training tasks, the training tasks characterizing processing of digital sensor data,
determining a parameter set for an architecture and for weights of an artificial neural network in a first phase with a first gradient-based learning algorithm and with a second gradient-based learning algorithm as a function of a plurality of first training tasks from the distribution of training tasks, the second gradient-based learning algorithm being a meta-learning algorithm, which ascertains an optimized parameter set as a function of the plurality of first training tasks and the parameter set,
training the artificial neural network in a second phase with the first gradient-based learning algorithm as a function of the optimized parameter set as a function of one second training task, and
processing the digital sensor data as a function of the artificial neural network; and
activating the computer-controlled machine as a function of an output signal of the trained device.

19. The method as recited in claim 18, wherein the computer-controlled machine is an at least semi-autonomous robot, or a vehicle, or a home application, or a power tool, or a personal assistance system, or an access control system.

20. The method as recited in claim 18, wherein the training data include image data, video data and/or digital sensor data of a sensor, from at least one camera and/or one infrared camera and/or one LIDAR sensor and/or one radar sensor and/or one acoustic sensor and/or one ultrasonic sensor and/or one receiver for a satellite navigation system and/or one rotational speed sensor and/or one torque sensor and/or one acceleration sensor and/or one position sensor.

21. A computer-implemented method for training a device for machine learning, classification or activation of a computer-controlled machine, the method comprising the following steps:
providing a plurality of training tasks from a distribution of training tasks, the training tasks characterizing the processing of digital sensor data;
determining a parameter set for an architecture and for weights of an artificial neural network in a first phase with a first gradient-based learning algorithm and a second gradient-based learning algorithm as a function of a plurality of first training tasks from the distribution of the training tasks, the second gradient-based learning algorithm being a meta-learning algorithm, which ascertains an optimized parameter set as a function of the plurality of the first training tasks and the parameter set; and
training the artificial neural network in a second phase with the first gradient-based learning algorithm as a function of the optimized parameter set and as a function of a second training task.

22. The method as recited in claim 21, wherein the artificial neural network is trained with the first gradient-based learning algorithm as a function of the parameter set and as a function of a second training task.

23. A device for processing digital sensor data for machine learning, classification or activation of a computer-controlled machine, comprising:
a processor; and
a memory for at least one artificial neural network;
wherein the processor is configured to:
provide a plurality of training tasks from a distribution of training tasks, the training tasks characterizing processing of digital sensor data;
determine a parameter set for an architecture and for weights of the artificial neural network in a first phase with a first gradient-based learning algorithm and with a second gradient-based learning algorithm as a function of a plurality of first training tasks from the distribution of training tasks, the second gradient-based learning algorithm being a meta-learning algorithm, which ascertains an optimized parameter set as a function of the plurality of first training tasks and the parameter set;
train the artificial neural network in a second phase with the first gradient-based learning algorithm as a function of the optimized parameter set as a function of one second training task; and
process the digital sensor data as a function of the artificial neural network.

24. A non-transitory machine-readable memory medium on which is stored a computer program for processing digital sensor data, the computer program, when executed by a computer, causing the computer to perform the following steps:
providing a plurality of training tasks from a distribution of training tasks, the training tasks characterizing processing of digital sensor data;
determining a parameter set for an architecture and for weights of an artificial neural network in a first phase with a first gradient-based learning algorithm and with a second gradient-based learning algorithm as a function of a plurality of first training tasks from the distribution of training tasks, the second gradient-based learning algorithm being a meta-learning algorithm, which ascertains an optimized parameter set as a function of the plurality of first training tasks and the parameter set;
training the artificial neural network in a second phase with the first gradient-based learning algorithm as a function of the optimized parameter set as a function of one second training task; and
processing the digital sensor data as a function of the artificial neural network.
